(19) United States
(12) Patent Application Publication
(10) Pub. No.: US 2007/0262120 A1
(43) Pub. Date: Nov. 15, 2007

(54) Lubricant for Quick Plastic Forming of Aluminum Sheet

(76) Inventors: Sydney Coleman, Southfield, MI (US); Bruce Goodreau, Romeo, MI (US)

Correspondence Address: HENKEL CORPORATION, THE TRIAD, SUITE 200, 2200 RENAISSANCE BLVD., GULPH MILLS, PA, 19406, US

(21) Appl. No.: 11/746,974

(22) Filed: May 10, 2007

Related U.S. Application Data
(60) Provisional application No. 60/799,115, filed on May 10, 2006.

(51) Int. Cl. A47J 36/02

(52) U.S. Cl. 228/101

(57) ABSTRACT

An aqueous lubricating composition comprising at least one divalent metal nitrate; at least one alkali metal hydroxide; at least one ionic surfactant; and at least one lubricant/release agent. Upon application to aluminum and titanium, the lubricating composition forms a dry film lubricant stable to heating to a temperature of 200 to 400° C., preferably 1100° C.

### CROSS-REFERENCE OF THE INVENTION

This invention claims priority from the U.S. Provisional Application Ser. No. 60/799,155, filed May 10, 2006.

### FIELD OF THE INVENTION

This invention relates to a lubricating composition for use in high temperature plastic forming of metal. More particularly, the invention relates to an aqueous liquid composition that is applied to metal and dried to form a heat stable film which is lubricious, plastic and adherent to metal substrates even at temperatures of 200 to 550° C., preferably to 1100° C. The lubricating composition of the invention is useful in high temperature plastic forming of metals that are capable of being deformed to elongations typically in excess of two hundred percent or more. More specifically, this invention relates to a lubricating composition for use in forming operations known in the art as “quick plastic forming” or “hot-gas plastic forming” which comprises the elevated temperature, controlled strain rate forming of such superplastic alloys.

### BACKGROUND OF THE INVENTION

It is known that certain metal alloys, such as some aluminum alloys and titanium alloys, when processed to a very fine grain size (e.g., <10 microns), can be heated to a relatively high processing temperature and subjected at a controlled strain rate to achieve total elongations before failure that are greater than those achieved with conventional forming techniques. For example, 5083 aluminum alloy and 7475 aluminum alloy and titanium alloys, such as Grade 5 titanium alloy comprising—6% aluminum—4% vanadium, in the form of cold rolled, fine grain sheets, can be processed by various hot-gas forming operations into quite complicated shapes in a single forming process. Exemplary alloys and the practices by which metal sheets can be formed by hot-gas forming are discussed in the Metals Handbook, 9th Edition, volume 14 entitled “Forming and Forging,” at pages 852-868 in the section entitled “Superplastic Sheet Forming”, as well as in U.S. Pat. Nos. 6,655,181 to Morales; 5,819,572 to Krajewski; 5,171,458 to Tsukiyama et al., and 5,139,887 to Sutton; incorporated herein by reference in their entirety.

In the above Metals Handbook section, eight aluminum alloy compositions and twelve titanium alloy compositions are described for which superplastic formability has been obtained. When the aluminum alloys are heated, for example, to a temperature in the range of 400° C. to 550° C. and subjected to strain at a rate ranging from about 1×10⁻⁴ to 5×10⁻³ per second, elongations of 400% to 1200% are obtained. Similarly, when fine grain titanium alloys are deformed at temperatures in the range of 815° C. to 1000° C. at strain rates of about 2×10⁻⁴ to 1×10⁻³ per second, elongations in the range of 100% to 1100% are achieved. A common characteristic of these alloys is that they have a very fine metallurgical grain size of the order of about 10 micrometers, and they are processed at a high temperature, usually greater than one-half of the absolute melting point temperature of the metal to be formed, and at a controlled strain rate usually in the range of 1×10⁻⁴ to 1×10⁻² per second.

Such alloys are usually processed in sheet form with a thickness of about one to three millimeters by a number of forming methods. The following forming methods have been used with such superplastic alloys: blow forming, vacuum forming, thermal forming, stretch forming and superplastic forming/diffusion bonding, and the like. Basically, such processes involve gripping a sheet of a superplastic formable alloy at its edges, heating the metal sheet to a suitable superplastic forming temperature, and subjecting one face of the metal sheet to the net pressure of a working fluid, either liquid or gas. The heated metal sheet is thus stretched at a suitable strain rate to expand the metal sheet against a mold cavity surface or a tool surface. Such practices are described in detail in the “Superplastic Sheet Forming” section of the above-identified volume of the Metals Handbook.

In such superplastic metal sheet forming operations, a lubricant/release agent is often used to (a) provide lubrication as the metal sheet slides against a forming surface, or (b) provide a stop-off layer between portions of two or more overlying metal sheets where it is wished to promote only localized diffusion bonding between the metal sheets as they undergo deformation, or (c) to release a formed metal sheet(s) from the die or tool member at the completion of the forming operation. Boron nitride and graphite are solid lubricants that have each been employed for such purposes.

Quick plastic forming (QPF) has been developed as a high volume, hot-gas forming process for aerospace and automobile components. Quick plastic forming is a larger volume application of the known super plastic forming processes which often use liquids to press the workpiece into the die. The QPF process essentially heats aluminum sheet to 350 to 450° C., places the hot metal sheet in a die that is configured on the bottom side with the upper die providing a gas cavity. Hot inert gas is pumped into the upper die, which forces the hot aluminum sheet to conform to the bottom die configuration, thereby forming the part. The aluminum and aluminum alloy parts formed are generally used in the automotive industry for the more decorative deck lids and trunks for automobiles and in the aerospace industry. One challenge in using the quick plastic forming technology has been controlling the interface between the die and the workpiece.

Typically, lubricants are used in this process to ease aluminum flow over the bottom configured die. The lubricants also act as a release aid to prevent parts from sticking to the die. Known lubricant technology includes a boron nitride, water-based slurry with a binder system to promote adhesion of the boron nitride to aluminum and graphite slurries. The boron nitride slurry and the graphite slurry have several drawbacks. First, the solid lubricant, e.g. boron nitride, tends to buildup quickly in the die, resulting in maintenance downtime for cleaning. If not removed regularly, this buildup can collect and harden in the die resulting in a defect on a freshly stamped part. Another drawback of the boron nitride lubricant is a heavy “white dust” created during forming which causes environmental and clean-up issues throughout the plant, likewise graphite produces a fine black dust having the same drawbacks. Finally, boron nitride is relatively expensive and increases the manufacturing cost per part.

### SUMMARY OF THE INVENTION

It is an object of the invention to provide a lubricating composition for use in high temperature metal forming that when dried on a surface produces a heat stable dry film lubricant. The dry film lubricant remains thermoplastic enough during stamping to allow good metal flow across the entire surface of the die and acts as a release agent to prevent parts from sticking in the die.

It is an object of the invention to provide a lubricating composition which is nonreactive with aluminum and its superplastic alloys, even at high temperatures of 350 to 450° C., typically used in quick plastic forming. It is a further object of the invention to provide such a lubricant which is nonreactive with titanium and its alloys even under high heat conditions of up to 1100° C. used for quick plastic forming of titanium and its alloys.

It is an object of the invention to provide a lubricating composition which provides a dry film that can be cleaned with conventional cleaning products, such as by way of non-limiting example, alkaline cleaners.

It is an object of the invention to provide a lubricating composition which adheres to aluminum and its alloys before and during the quick plastic forming operation, without staining the workpiece under high heat conditions of up to 550° C. It is a further object of the invention to provide such a lubricant for quick plastic forming of titanium and its alloys which adheres to the workpiece before and during the quick plastic forming operation, without staining the titanium and its alloys under high heat conditions of up to 1100° C.

These and other objects of the invention are met by a lubricating composition according to the invention.

In one embodiment, the lubricating composition comprises distilled water and:

calcium nitrate at 1.41%;

sodium hydroxide (50%) at 0.10%; and

ionic surfactant, preferably an ethoxylated acetylenic diol at 0.10%.

It is another object of the invention to provide a method of forming a sheet of superplastic aluminum or titanium alloy by forcing a side of the metal sheet into conformance with the surface of a shaping tool or die, the method comprising applying a lubricant to at least one of (a) the surface of the shaping tool or die and (b) the side of the metal sheet to be contacted with and conformed to the shape of the tool or die, drying the applied lubricating composition to form a dry film lubricant, heating the metal sheet to a superplastic forming temperature, applying fluid pressure to the opposite side of the metal sheet so as to deform the metal sheet at a superplastic strain rate into conformance with the tool or die surface, and thereafter removing the deformed metal sheet from the tool or die surface; wherein the lubricant comprises calcium nitrate, sodium hydroxide, a lubricant/release agent and a surfactant.

It is a yet further object of the invention to provide the method wherein the metal sheet is an aluminum alloy and the lubricating composition forms a calcium aluminate salt on the metal sheet, which is then dried to form a dry film lubricant comprising calcium aluminate.

Other than in the operating examples, or where otherwise indicated, all numbers expressing quantities of ingredients, reaction conditions, or defining ingredient parameters used herein are to be understood as modified in all instances by the term “about”. Unless otherwise indicated, all percentages are percent by weight.

### DETAILED DESCRIPTION OF A PREFERRED EMBODIMENT

An aqueous lubricating composition according to the invention is made by mixing together a first mass of water and at least the following components:

(A) a second mass of at least one nitrate salt of a divalent metal;

(B) a third mass of at least one alkali metal hydroxide;

(C) a fourth mass of at least one ionic surfactant; and

(D) a fifth mass of at least one lubricant/release agent.

The aqueous lubricating composition is applied to surfaces of aluminum, titanium and/or their alloys to be formed. Upon drying the composition forms a dry film lubricant that is stable to heating to a temperature of at least with increasing preference in the order given about 200, 250, 300, 350, 375, 400, 450, 500, 550, 600, 650, 700, 750, 800, 850, 900, 950, 100, 1050, 1100° C. Those of skill in the art will understand “stable to heating” to mean that the substance heated does not decompose, smoke excessively, flash, burn, flake off, fracture or lose its lubricity or plasticity during or after heating.

The aqueous lubricating composition comprises (A) at least one nitrate salt of a divalent metal. The nitrate salt is water soluble and present in an amount, in increasing order of preference of at least 0.4, 0.45, 0.5, 0.6, 0.7, 0.8, 0.9, 1.0, 1.4, 1.45, 1.5, 1.6, 1.7, 1.8, 1.9, 2.0 wt % and not more than, in increasing order of preference 5.0, 4.75, 4.5, 4.0, 3.5, 3.0, 2.5, 2.25 wt % of the nitrate salt. Suitable nitrate salts are those of water soluble salts of divalent metals of Groups 2-6 of the periodic table of elements, preferably calcium. In a preferred embodiment, (A) comprises calcium nitrate in an amount of 1.41 wt %.

Suitable caustics for component (B) include at least one alkali metal hydroxide, such as lithium, sodium and potassium hydroxides and mixtures thereof. The alkali metal hydroxide is present in an amount, in increasing order of preference of at least 0.025, 0.03, 0.035, 0.04, 0.045, 0.05, 0.06, 0.07, 0.08, 0.09, 0.10, 0.14, 0.15, 0.16, 0.17, 0.18, 0.19, 0.20 wt % and not more than, in increasing order of preference 0.35, 0.33, 0.30, 0.28, 0.26, 0.25, 0.24, 0.23, 0.22, 0.21 wt %. In one embodiment the at least one alkali metal hydroxide comprises sodium hydroxide in an amount of 0.05 wt %.

The lubricating composition of the invention further comprises (C) at least one surfactant. Any heat stable surfactant known to those of skill in the art can be used provided it does not interfere with the performance of the lubricating composition or dry film lubricant. Ionic surfactants are preferred. Suitable surfactants include those falling within the classification of substances known as acetylenic diols and ethoxylated acetylenic diols. By way of non-limiting example, surfactants such as ethoxylated 2,4,7,9-tetramethyl-5-decyne-4,7-diol and 2,4,7,9-tetramethyl-5-decyne-4,7-diol are suitable. The surfactant is present in an amount, in increasing order of preference of at least 0.025, 0.03, 0.035, 0.04, 0.045, 0.05, 0.06, 0.07, 0.08, 0.09, 0.10, 0.14, 0.15, 0.16, 0.17, 0.18, 0.19, 0.20 wt % and not more than, in increasing order of preference 0.35, 0.33, 0.30, 0.28, 0.26, 0.25, 0.24, 0.23, 0.22, 0.21 wt %. In one embodiment, the at least one surfactant comprises an ionic surfactant present in an amount of 0.10%.

The aqueous lubricating composition also comprises (D) at least one lubricant/release agent. Suitable lubricant/release agents are those heat stable compositions that provide sufficient lubricity to the metal sheet during quick plastic forming operations, even at temperatures of 200 to 550° C., preferably to 1100° C., such that the flow of the metal over the die is improved as compared to the flow of metal in the presence of a comparable lubricating composition in the absence of the lubricant/release agent. The lubricant/release agent is present in an amount, in increasing order of preference of at least 1, 2, 3, 4, 5, 6, 7, 8, 9 or 10 wt %, and not more than, in increasing order of preference 20, 19, 18, 17, 16, 15, 14, 13, 12, 11 wt %. In one embodiment, the lubricant/release agent is present in an amount of to 1.5 to 10 wt %.

The lubricant/release agent can be soluble, insoluble or sparingly soluble in the lubricating composition, provided that it does not interfere with the formation of the dry film lubricant upon evaporation of water from the as-coated metal sheet. Desirably the lubricant/release agent is selected from the group consisting of at least one of polytetrafluoroethylene, silicon dioxide, sodium thiosulfate, calcium oxide, sodium nitrite and hectorite clay. Embodiments of the invention having coefficients of friction of less than 0.35 are preferred and had lubricant/release agents comprising PTFE alone or a combination of PTFE, sodium nitrite and calcium oxide; or a combination of sodium thiosulfate and calcium oxide.

It is further desirable that the lubricant/release agent does not interfere with removal of the dry film lubricant after forming or build-up on the die.

Lubricating compositions as described herein are generally used in quick plastic forming where high temperature stability and easy removal of lubricants is necessary. The invention also includes a method of forming a metal sheet of a superplastic aluminum or titanium alloy by forcing a side of the metal sheet into conformance with the surface of a shaping tool or die, the method comprising applying a lubricant to at least one of (a) the surface of the shaping tool or die and (b) the side of the metal sheet to be contacted with and conformed to the shape of the tool or die, drying the applied lubricating composition to form a dry film lubricant, heating the metal sheet to a superplastic forming temperature, applying fluid pressure to the opposite side of the metal sheet so as to deform the metal sheet at a superplastic strain rate into conformance with the tool or die surface, and thereafter removing the deformed metal sheet from the tool or die surface; wherein the lubricating composition comprises at least one nitrate salt of a divalent metal, at least one alkali metal hydroxide, at least one surfactant, and at least one lubricant/release agent. The method may further comprise the optional step of cleaning the dry film lubricant from the deformed metal sheet and optionally etching the surface of the sheet, during cleaning or in a separate etching step. Suitable compositions for cleaning and etching in one step are known to those of skill in the art and include hydrofluorosilicate compositions.

The manner of depositing the lubricating composition can be those typically used for applying waterborne lubricants, including but not limited to roll coating, dipping, spraying or using a drawdown bar. The time of contact with the lubricating composition is in increasing order of preference at least about 5, 6, 7, 8, 9, 10, 11, 12, 13, 14, 15 minutes, and not more than, in increasing order of preference, at least for economy 60, 50, 40, 35, 30, 25, 20 minutes. Working temperatures for the coating bath range from ambient temperature to below the boiling point of the working bath. Generally, the bath is heated to accelerate the deposition of the lubricating composition onto the metal sheets, but not to greater than 200° F. to limit evaporation of water from the bath. Typical working bath temperatures are in increasing order of preference at least 100, 110, 120, 130, 140 or 150° F. and not more than, in increasing order of preference, 220, 210, 200, 190, 180, 170, 160° F.

The metal sheet is then dried at ambient or at elevated temperature to form a dry film lubricant on the surfaces of the metal sheet. Forming may take place as soon as the film has dried. The metal sheet is then subjected to quick plastic forming processes which are known to those of skill in the art.

Suitable substrates for use in the method include superplastic metal alloys such as aluminum alloys and titanium alloys. Desirably, the metal sheet is an aluminum alloy and the lubricating composition applied to the metal sheet forms a calcium aluminate salt on at least one surface of the metal sheet.

The practice of this invention may be further appreciated by consideration of the following, non-limiting, working examples.

### EXAMPLES

Calcium aluminate is known to form a powdery film that could be rubbed off of an aluminum panel surface. Applicants recognized that calcium aluminate was adherent enough to bind on a surface, would not decompose under high heat (decomposes at 1535° C., and yet could be easily cleaned from a surface. Distilled water (hereinafter referred to herein as “DI water”) was selected as a carrier to prevent water hardness interference from tap water in the formation of the lubricious dry film by generation of undesirable salts.

### Example 1

1968 grams of DI water was heated to 150° F. Thirty grams of calcium nitrate salt was dissolved in the hot DI water to form a clear solution. In order to drive the reaction, five grams of sodium hydroxide (50%) was introduced to the formula. A white flocculent formed, which was determined to be CaOH. When an aluminum panel was introduced to the bath, a grey powdery substance was developed on the panel surface. This powdery film was identified as calcium aluminate. Without being bound by a single theory, it is believed that the calcium aluminate was generated by reactions as shown in the following equation:

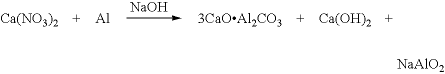

CaO.Al₂O₃: calcium aluminate is the powdery grey material deposited on the aluminum panel surface;

Ca(OH)₂: calcium hydroxide is an insoluble flocculent reaction product; and

NaAlO₂: sodium aluminate is a water soluble salt that is a reaction by-product.

### Example 2

Applicants initially investigated three materials to improve lubricity and help as anti-stick or lubricant/release agents. Polytetrafluoroethylene (PTFE), silicon dioxide, and sodium thiosulfate, as well as surfactant, were introduced to an aqueous solution of nitrate salt and caustic as recited in Table 1, according to the procedure of Example 1. The amounts of components are in grams.

For each formulation a clean 6×4 inch panel of 6111 aluminum was weighed and immersed in the solution for 20 minutes at 150° F. The panels were removed, inspected for coating and reweighed, see Table 1.

TABLE 1

| Sample | | | | | | | | |
|---|---|---|---|---|---|---|---|---|
| (g) | 1 | 2 | 3 | L-1 | L-2 | L-3 | L-4 | L-5 |
| DI water | 1968 | 1968 | 1968 | 1968 | 1968 | 1968 | 1968 | 1968 |
| Ca(NO₃)₂ | 30 | 30 | 30 | 30 | 30 | 30 | 30 | 30 |
| NaOH (50 wt % | 5 | 7 | 7 | 5 | 5 | 5 | 5 | 5 |
| solution) | | | | | | | | |
| Surfactant | 10 | 10 | 10 | 10 | 10 | 15 | 5 | 10 |
| Silicon Dioxide | 100 | 100 | 50 | | | | | |
| PTFE | | | | 100 | 50 | 50 | 125 | |
| Na thiosulfate | | | | | | | | 50 |
| Coating Weight | 0.0501 | Poor | 0.0899 | 1.0454 | 0.9305 | Stained, | 1.4069 | 0.5497 |
| | | coverage | | | | no | | |
| | | | | | | coating | | |

### Example 3

Polytetrafluoroethylene (PTFE), silicon dioxide, sodium thiosulfate, calcium oxide, sodium nitrite and hectorite clay (a montmorillonite mineral having an empirical formula of Na_{0.67}(Mg, Li)₆Si₈O₂₀(OH,F)₄) were selected for further study as lubricant/release agents based on their relative heat resistance. The silicon dioxide used had to disperse readily in water so nanoparticle size silicon dioxide, brand name Ludox CL-P, commercially available from W. R. Grace & Co., was chosen.

Compositions were made according to the procedure of Example 1, with the following ingredients making up CA-1, in weight percent:

| | |
|---|---|
| DI water | 98.25% |
| calcium nitrate | 1.5% |
| sodium hydroxide (50 wt % solution) | 0.25% |

### Other additives were as recited in Table 2. For each formulation a clean 6×4 inch panel of 6111 aluminum was immersed in the solution for 30 minutes at 150° F. The panels were removed and inspected for coating, see Table 2.

TABLE 2

| Composition | Formulation | Appearance |
|---|---|---|
| M1 | CA-1 with 4.7 wt % Ludox CL-P | Poor coating, not uniform. Poor plate out |
| | | of the aluminate. SiO₂ nanoparticles |
| | | seemed to physically interfere with a |
| | | uniform surface coating. Wetting of the |
| | | panel was not a uniform sheet. |
| M2 | CA-1 with 6.95 wt % of sodium | Excellent tight coating, very uniform grey- |
| | thiosulfate | white upon drying. Sodium thiosulfate |
| | | appears to have profound affect on |
| | | coating. Wetting could be improved. |
| M3 | CA-1 with 5.9 wt % of PTFE | White frosty appearance, very uniform. |
| | | Wetting could be improved. |
| M4 | CA-1 with 2.76 wt % PTFE, 2.3 | White powdery appearance; extremely |
| | wt % sodium nitrite and 2.3 wt % | uniform dry film on aluminum panel. |
| | calcium oxide | |
| M5 | CA-1 with 2.37 wt % sodium | White crystal-like appearance; extremely |
| | thiosulfate and 2.37 wt % calcium | uniform dry film on aluminum panel. |
| | oxide | |
| M6 | CA-1 with 3.58 wt % calcium oxide | White powdery appearance; moderately |
| | and 0.48 wt % hectorite clay | uniform dry film on aluminum panel. |

### Example 4

To improve wetting and minimize foam, addition of various surfactants was investigated. Commercially available acetylenic diols are known to wet out surfaces, are low foam and generally are compatible with dry film coatings such as paints. The compositions were built according to Example 3, with the addition of 5 grams of surfactant. Panels were coated according to Example 3. Each surfactant tested produced similar results for lubricating compositions M1-M3 upon observing the solution and resulting dry film, see Table 3.

TABLE 3

| Surfactant | Observations |
|---|---|
| A commercial surfactant identified as a | Low foam, wetting okay, |
| ethoxylated acetylenic diol | uniform dry film |
| (5 grams) | |
| A commercial ethoxylated diol surfactant | Low foam, wetting okay, |
| identified as ethoxylated 2,4,7,9-tetramethyl- | dry film is very uniform |
| 5-decyne-4,7-diol | |
| (5 grams) | |
| A commercial acetylenic diol identified as | Foam is medium, wetting is |
| 2,4,7,9-tetramethyl-5-decyne-4,7-diol | fair, dry film has excellent |
| (5 grams) | uniformity |

### Example 5

Performance parameters for use in manufacturing were assessed including uniformity of the dry film and lubricity of the dry film lubricant, as expressed in coefficient of friction measurements. Panels were coated using M1-M6 formulations according to the procedure of Example 3, and dried in an oven set at 150° F. The films were then observed and recorded in Table 4.

TABLE 4

| Formulation | Dry Film Appearance |
|---|---|
| CA-1 (no additive) | Uniform grey powdery film very uniform and complete on panel |
| CA-1 + Ludox CL-P | It appears the Ludox material (silicon dioxide) compromised the |
| | calcium aluminate coating. The final coating on the aluminum |
| | panel was grey with white streaks. The final film was not |
| | uniform. |
| CA-1 + Sodium Thiousulfate | White-grey film very uniform. It appeared the two salts (calcium |
| | aluminate and sodium thiosulfate) intertwined well and plate out |
| | on the aluminum panel surface with extreme uniformity |
| CA-1 + PTFE | White uniform film. The white film appeared raised. Adhesion |
| | was good. |
| CA-1 with PTFE, sodium nitrite | White powdery film. Slightly raised surface. Adhesion is good. |
| and calcium oxide | |
| CA-1 with sodium thiosulfate and | White crystal-like film. Adhesion is excellent. |
| calcium oxide | |
| CA-1 with calcium oxide and | Off-white powdery film. Adhesion is excellent. |
| hectorite clay | |

### Lubrication Testing via Cetr Testing

Procedure: Panels were coated using M1-M6 formulations according to the procedure of Example 3, and dried in an oven set at 150° F. Used Cetr UMT-2 Lubrication tester on the thus coated 6111 aluminum coupons. The coefficient of sliding friction is reported in Table 5, below. In general, when comparing “like chemistries”, the lower the coefficient of friction, the better the lubricant.

TABLE 5

| | Coefficient of |
|---|---|
| Formulation | Friction |
| CA-1 with PTFE, sodium nitrite and calcium oxide | .27 |
| CA-1 + PTFE | .31 |
| CA-1 with sodium thiosulfate and calcium oxide | .34 |
| CA-1 + Sodium Thiosulfate | .39 |
| CA-1 with calcium oxide and hectorite clay | .39 |
| CA-1 + Ludox CL-P | .45 |
| CA-1 (no additive) | .48 |

### Example 6

### Adhesion to the Metallic Surfaces

Measurements of adhesion to the substrate metal were made for all film coated panels of Table 2, at room temperature and after heating treatments at 450° C. during five minutes under an air atmosphere. Adhesion can be measured using a Crockmeter; the Crockmeter rubs a given area using a felt protected tool called the finger to consistently rub a known area with a predetermined amount of strokes. Aluminum panels prepared with the dry film lubricant candidates of Table 2 were stroked (the stroke rubs an area one-half inch by 4 inches) 20 times on an area. Both unheated and heated coated panels (460° C.) were tested with the Crockmeter. The weight loss in milligrams per square foot is reported in Table 6, below. The initial coating weights on the tested panels were between 700-1000 milligrams per square foot per side for this experiment.

TABLE 6

| Formulation | Heated | Un-Heated |
|---|---|---|
| CA-1 + Ludox CL-P | 18.2 | 15.5 |
| CA-1 + Sodium Thiosulfate | 4.1 | 3.4 |
| CA-1 + PTFE | 7.6 | 6.8 |
| CA-1 with PTFE, sodium nitrite and calcium oxide | 7.0 | 3.3 |
| CA-1 with sodium thiosulfate and calcium oxide | 7.3 | 1.6 |
| CA-1 with calcium oxide and hectorite clay | 8.0 | 8.0 |

*Greater than 18 milligrams per square foot means the area has been rubbed to bare metal.

Analysis of the results showed that the lubricant formulation comprising CA-1+sodium thiosulfate shows the best adhesion before heating and after heating for the QPF process.

This invention provides a lubricant combination that can be used at the high temperatures of superplastic forming of aluminum alloy and titanium alloy sheets. It can be used in many variations of the processes that are employed in the superplastic forming of metal sheet materials. While the invention has been described in terms of specific embodiments thereof, it will be appreciated that other forms could readily be adapted by one skilled in the art. Accordingly, the scope of the invention is to be considered limited only by the following claims.

What is claimed is:

1. A method of forming a metal sheet of a superplastic aluminum or titanium alloy by forcing a side of the metal sheet into conformance with the surface of a shaping tool or die, the method comprising:
applying a heat stable lubricating composition to at least one of (a) the surface of the shaping tool or die and (b) said side of the metal sheet to be conformed to the shape of the tool or die;
drying the applied heat resistant lubricating composition to form a dry film lubricant;
heating the metal sheet to a superplastic forming temperature;
applying fluid pressure to the opposite side of the metal sheet so as to deform the metal sheet at a superplastic strain rate into conformance with the tool or die surface, and thereafter;
removing the deformed metal sheet from the tool or die surface;
wherein the heat resistant lubricating composition comprises at least one nitrate salt of a divalent metal, at least one alkali metal hydroxide, at least one surfactant, and at least one lubricant/release agent.

2. A method as recited in claim 1 in which said superplastic metal alloy is an aluminum alloy.

3. A method as recited in claim 1 in which said superplastic metal alloy is titanium alloy.

4. A method as recited in claim 1 where said lubricant composition is a dispersion of PTFE in a non-solvent, liquid vehicle.

5. A method as recited in claim 1 wherein the metal sheet is an aluminum alloy and said lubricant composition applied to the metal sheet forms a calcium aluminate salt on at least one surface of the metal sheet.

6. A method as recited in claim 1 wherein said lubricant composition comprises:
(A) 0.5 to 4.5% of the at least one nitrate salt of a divalent metal;
(B) 0.03 to about 0.30% of the at least one alkali metal hydroxide;
(C) 0.03 to about 0.30% of the at least one ionic surfactant; and
(D) 2 to about 18% of the at least one lubricant/release agent.

7. A method as recited in claim 1 wherein said lubricant composition comprises:
(A) calcium nitrate in an amount of 1.41%;
(B) sodium hydroxide in an amount of 0.05%;
(C) an ethoxylated acetylenic diol surfactant in an amount of 0.10%; and
(D) 1.5 to 10% of a lubricant/release agent selected from the group consisting of at least one of polytetrafluoroethylene, silicon dioxide, sodium thiosulfate, calcium oxide, sodium nitrite and hectorite clay.

8. An aqueous lubricating composition made by mixing together a first mass of water and at least the following components:
(A) a second mass of at least one nitrate salt of a divalent metal;
(B) a third mass of at least one alkali metal hydroxide;
(C) a fourth mass of at least one ionic surfactant; and
(D) a fifth mass of at least one lubricant/release agent;
said composition forming a dry film lubricant upon application to aluminum and titanium, said dry film lubricant being stable to heating to a temperature of 200 to 1100° C.

9. The aqueous lubricating composition of claim 8 comprising:
(A) 0.5 to 4.5% of the at least one nitrate salt of a divalent metal;
(B) 0.03 to about 0.30% of the at least one alkali metal hydroxide;
(C) 0.03 to about 0.30% of the at least one ionic surfactant; and
(D) 2 to about 18% of the at least one lubricant/release agent.

10. The aqueous lubricating composition of claim 8 comprising:
(A) calcium nitrate in an amount of 1.41%;
(B) sodium hydroxide in an amount of 0.05%;
(C) an acetylenic diol surfactant in an amount of 0.10%; and
(D) 1.5 to 10% of a lubricant/release agent selected from the group consisting of at least one of polytetrafluoroethylene, silicon dioxide, sodium thiosulfate, calcium oxide, sodium nitrite and hectorite clay.

11. The aqueous lubricating composition of claim 8 wherein the lubricant/release agent comprises a mixture of PTFE, sodium nitrite and calcium oxide.

12. The aqueous lubricating composition of claim 8 wherein the lubricant/release agent comprises a mixture of sodium thiosulfate and calcium oxide.

13. The aqueous lubricating composition of claim 8 wherein the lubricant/release agent comprises PTFE and/or sodium thiosulfate.

14. An article of manufacture comprising a metal sheet of aluminum, titanium or alloys of aluminum or titanium, said metal sheet having deposited on at least one surface of the metal sheet a dry film lubricant, said dry film lubricant comprising the reaction products of said at least one surface and:
(A) at least one nitrate salt of a divalent metal;
(B) at least one alkali metal hydroxide;
in the presence of at least one ionic surfactant, at least one lubricant/release agent and optionally water;
said dry film lubricant being heat stable to temperatures of at least 200° C.
